(19) United States
(12) Patent Application Publication
(10) Pub. No.: US 2025/0257938 A1
(43) Pub. Date: Aug. 14, 2025

(54) Beverage preparation system to quickly chill/heat and/or aerate any beverage in a container and minimize contamination of beverage liquid

(71) Applicant: Derrick Du, San Jose, CA (US)

(72) Inventor: Derrick Du, San Jose, CA (US)

(21) Appl. No.: 18/436,983

(22) Filed: Feb. 8, 2024

(51) Int. Cl. F25D 31/00; A47J 31/46; A47J 31/52; A47J 31/60

(52) U.S. Cl. CPC F25D 31/005; A47J 31/461; A47J 31/468; A47J 31/5253; A47J 31/60; F25D 31/002

(57) ABSTRACT

The present invention comprises a novel beverage preparation system for home and commercial use. This invention can chill or heat any beverage liquid in any volume to a sub-freezing or sub-boiling temperature specified in a short duration and to precise temperatures while minimizing contact of beverage liquids with internal components to limit cross contamination between beverages and between beverages and the cleaning processes. The system keeps the beverage as pure to the original as possible by limiting any residual liquids that may remain in the system and a method to clean and flush internal passageways. The system can aerate beverages with precise amounts of air.

### FIELD OF THE INVENTION

The present invention relates to a beverage preparation system that limits contact of beverage liquids with internal components to minimize contamination of beverage between dispenses and from cleaning to dispensing. In particular, the system quickly chills and aerates a beverage from any container.

### BACKGROUND

People love a cold beverage on a warm day. You can purchase cold beverages from the store, but many times beverages may be stored in a non-refrigerated space. Consumers may utilize their own refrigerator to store and keep their beverages cold, but this may keep your beverage too cold or take up too much space in the refrigerator where there is limited real estate.

For those beverages where the temperature just needs to be cold, one beverage may take hours to get to a cold enough state in a normal refrigerator. Another method may be to use ice cubes, but the ice will melt and dilute your beverage. If you were to put the beverage in the freezer to accelerate the chilling process, your beverage may explode from freezing causing a big mess and a big inconvenience.

Furthermore, many beverages should be consumed at an exact temperature and aeration to maximize the flavors, particularly complex alcohols like fine wines and spirits. If these alcoholic beverages are served too warm, the alcohol has more of a bite and overwhelms the beverages actual flavors. If the alcoholic beverage is served too cold, the flavors you want are dulled down. Currently, there is no known method to bring a beverage to the perfect temperature. There are starting to be products that offer this solution for warm beverages (e.g. Ember Cup), but none for cold beverages.

For complex alcohols, aerating the drink can also open up different flavors in the beverage.

There are refrigerators that can be set to specific temperatures, but they are not precise and have hot and cold spots internally. Additionally, these refrigerators have a limited number of temperatures that can be set for different beverages and can take hours to bring a beverage to the correct temperature.

Ensuring there is no contamination of water from cleaning or from liquids from a previous dispense are important to retain the ideal taste of the beverage as intended by the beverage maker. This is important for partnerships with the beverage makers to represent their brands.

Therefore, a need exists for a system that can quickly chill or heat a beverage and thoroughly clean the internals of the system without contaminating the beverages.

The present invention does not preclude other applications for chilling, heating, or aerating beverages.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 is an exemplary illustration of the beverage dispensing system architecture and how each component is connected in accordance with one embodiment of the invention.

FIG. 2 is an exemplary illustration of how the cooling system functions and is connected to the other systems in accordance with one embodiment of the invention.

FIG. 3 is an exemplary illustration of how an alternative cooling system architecture in accordance with one embodiment of the invention

FIG. 4 is an exemplary illustration of how an alternative cooling system architecture in accordance with one embodiment of the invention

FIG. 5 is an exemplary illustration of the chill block internals in accordance with one embodiment of the invention

FIG. 6 is an exemplary illustration of the exterior of the system

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a”, “an”, and “the” are intended to include the plural forms as well as the singular forms, unless the context clearly indicates otherwise. It will be further understood that the terms “comprises” and/or “comprising”, when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these individual techniques include various benefits and each technique can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New methods for chilling and aerating a beverage and how to create a more efficient cleaning method, more affordable, and better sized system are discussed herein. In the following description, for purpose of explanation, numerous specific details are set forth in order to provide a thorough understanding of the present invention. It will be evident, however, to one skilled in the art that the present invention may be practiced without particular aspects of these details.

The present disclosure is to be considered as an exemplification of the invention, and is not intended to limit the invention to the specific embodiments illustrated by the figures or description below.

### System

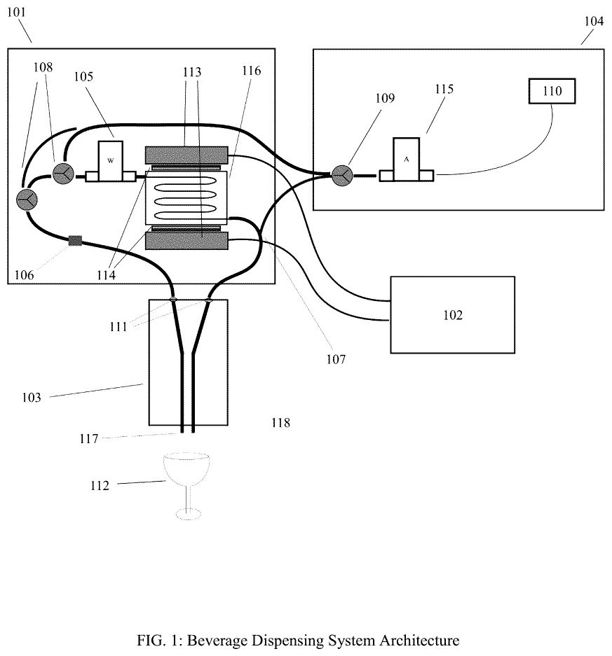

FIG. 1 is an exemplary illustration of the beverage dispensing system architecture. A user may have a beverage container 112, which can be a glass, bottle, bowl, cup, mug, or any container, with a beverage inside to be chilled and aerated. The straw system 103 includes an input tube 117, an output tube 118, and a straw interface 111 to the rest of the chiller loop 101. In some embodiments, the straw system 103 may have various lengths of input tube 117 and output tube 118 to accommodate varying sizes of beverage containers 112. The straw interface 111 enables a quick and easy method of changing the straw system 103 with the correct length version for the beverage container 112 or for cleaning. To utilize the straw system 103, the input tube 117 and output tube 118 are placed into the beverage container 112 containing the beverage, and the straw system 103 with the beverage container 112 are installed onto the system. In another embodiment, the user may adjust the relative height of beverage container 112 with an adjustable height drip tray (not shown in the figures). In another embodiment, input tube 117 and output tube 118 can vary in length depending on the beverage. For example, the lengths of input and output tube 117/118 may be adjustable by a motorized mechanism or manually by the user. The length of input tube 117 and output tube 118 may vary through a telescopic design or extensions added through modular tubing.

When the system is dispensing or cleaning, the input tube 117 suctions the beverage into the straw system 103 and passes through the straw interface 111 to the chiller loop 101. The beverage returns from the chiller loop 101 through the straw interface 111 into the straw system 103 and back out to the beverage container 112 through the output tube 118.

As the beverage passes through the chiller loop 101, the beverage is chilled and aerated. Following the beverage through the chiller loop 101 from the input tube 117 to output tube 118, there is 1) a temperature sensor 106 to measure the current temperature of the beverage, 2) flushing valves 108 for cleaning the system, 3) a beverage pump 105 to bring the beverage into the system, 4) a chill block 116 for chilling the beverage and 5) an aerator 107 pushing air from the aeration system 104 to aerate the beverage. In embodiments, the temperature sensor 106 is on the input side of the chiller loop 101 because the beverage on the input side will be closest to the average beverage temperature in the beverage container 112. In embodiments, an aerator 107 is located on the output side of the chiller loop 101 to aerate the beverage. The aerator 107 is on the output side of the chiller loop 101 because air in the chill block 116 will result in inefficient thermal exchange of the beverage, thus aeration may occur any time after cooling/heating of the beverage. In another embodiment, the temperature sensor 106 is installed on or near the bottom of the input tube 117 and output tube 118 to take the beverage temperature before pumping begins. The flushing valves 108 may direct the beverage from the temperature sensor 106 to the chill block 116 or configured to direct air to the input tube 117 and output tube 118 for flushing of the system described further below. The flushing valves 108 may include two 3-way valves or a T-port valve.

When the chiller loop 101 is chilling the beverage, the beverage circulates from the beverage container 112 to the input tube 117 through the chiller loop 101 and back to the beverage container 112 through the output tube 118 until the temperature sensor 106 shows a target temperature of the beverage is met. The beverage may then be flushed from the system through the process described further below.

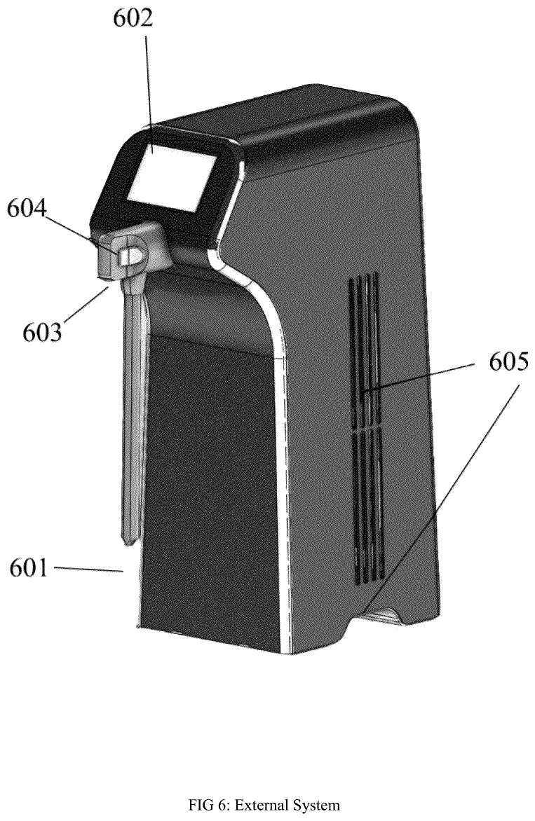

FIG. 6 is an exemplary illustration of an exterior design for the system 601. In embodiments, the system is tall enough for the straw system 603, used to suction the beverage into the system and push the beverage out of the system 601, to be at a height taller than a beverage container (e.g., a bottle of wine). The bottle of wine can be between 5 and 15 inches tall. Straw system buttons 604 allow the user to remove the straw system 603 from the system in order to place the straw system 603 in a beverage container 112, replace the straw system 603 with a different sized one, or for cleaning. The straw system 603 is an illustration of the straw system 603 specified in FIGS. 1-103. The LCD screen 602 is placed near the top of the unit for easy access and visibility. However, the LCD screen 602 may be placed in any available location of the device easily visible to a user. In another embodiment, the straw system 603 may rotate front and back or left and right to allow easier installation into user's beverage container 112 without removal from the system. In embodiments, the beverage dispensing system has vents 605 to facilitate cool air flow into the system and an output vent is on the back of the system (not shown in figures) to expel hot air.

### Flushing

In embodiments, liquids are flushed from the system by first turning off the beverage pump 105 and turning on the air pump 115 while redirecting air through the flushing valves 108 and air valve 109 to push and agitate the liquids from the flushing valves 108 out the input tube 117. The directionality of the flushing valves 108 may then be changed to redirect the air to push and agitate the liquids from the flushing valves 108 out of the output tube 118. The air valve 109 controls if air is directed from the air pump to the flushing valves 108 or to the aerator 107.

Another method of removing beverage remnants from the output tube 118 is to turn on the air pump 115, and redirect the air valve 109 to the aerator 107. This would utilize the air to push and agitate any remaining beverage remnants closer to the source on the output tubing 118 and maximize removal of beverage remnants.

A flushing of the input tube 117 and output tube 118 may occur at the end of a dispense, at the end of a cleaning, or separately selected as an operational option as requested by a user. The purpose behind the separately commanded flush is to remove any beverage remnants that may remain when the ends of the input tube 117 and output tube 118 are not submerged in any liquids. For example, when a user has dispensed their beverage, the glass may be lowered to further capture any remaining drops of liquid that may remain in the beverage tube. In some embodiments, the remaining drops of liquid may be near the ends of the beverage tube.

### Aeration

As the beverage passes through the aerator 107, the air pump 115 directs air through air valve 109 to the aerator 107. In embodiments, an air gap 110 is located at the back of the system to pump fresh air from outside the system. In embodiments, an air pump 115 duty cycle is chosen based on the amount of aeration needed for the beverage vessel type and/or beverage identified. Since the volume of beverage being chilled is unknown, an estimate of the volume of beverage is determined by the duration of time taken to chill or heat the beverage. For example, an estimated volume of beverage may be determined based on the duration to chill or heat the beverage by 1 degree. Based on this estimated volume of the beverage along with an estimated pump speed, a duty cycle of the air pump is adjusted to ensure all of the beverage is being aerated. For each beverage, the calculation for the estimated volume may be different. For example, coffee may have a better thermal transfer than whiskey. In another embodiment, the aeration is using a venturi effect, resulting in a fixed amount of aeration.

### Cleaning

In embodiments, to ensure there is no water or beverage remnants in the system, the beverage pump 105 is placed at the highest point in the system. All components in the chiller loop 101 after the beverage pump 105 may have a downward slope of at least 2 degrees, including the route within the chill block 116. In another embodiment, the flushing valves 108 are the highest point in the system with the beverage pump 105 as close to the flushing valves 108 as possible.

When a cleaning is required, particularly after changes in the beverage type, the system may request the user to fill a beverage container 112 with water and vinegar or other food-safe cleaning solution, place the input tube 117 and output tube 118 in the respective cleaning container and install the straw system 103 and beverage container 112 to the system. When performing the cleaning, the liquid in the beverage container 112 may be pumped by the beverage pump 105 through the chiller loop 101 (without chilling) until the cleaning is completed. In embodiments, if a deep clean is selected and vinegar or other food-safe cleaning solution is utilized, the beverage pump 105 pumps the food-safe cleaning solution through the system for at least 1 minute to ensure the food-safe cleaning solution kills and removes any bacteria and build up inside the system. If a normal clean is selected and water is utilized, the beverage pump 105 pumps the water through the system for less than 1 minute to remove any residual liquids and sugars in the system.

In embodiments, after the system is cleaned, a flush following the steps in the flush section above is performed. With all the tubes angled downward towards the input tube 117 and output tube 118, the liquids may easily be flushed from the system.

In another embodiment, the system contains an internal water tank that is used to hold the water or food-safe cleaning solution for the cleanings to perform cleanings from the internal water tank. In another embodiment, the system contains a wastewater tank that is used to contain the wastewater from the cleanings. This wastewater tank may also be utilized as a drip tray. In embodiments, the wastewater tank may be configured to contain more than 50 ml of liquids.

### Cooling

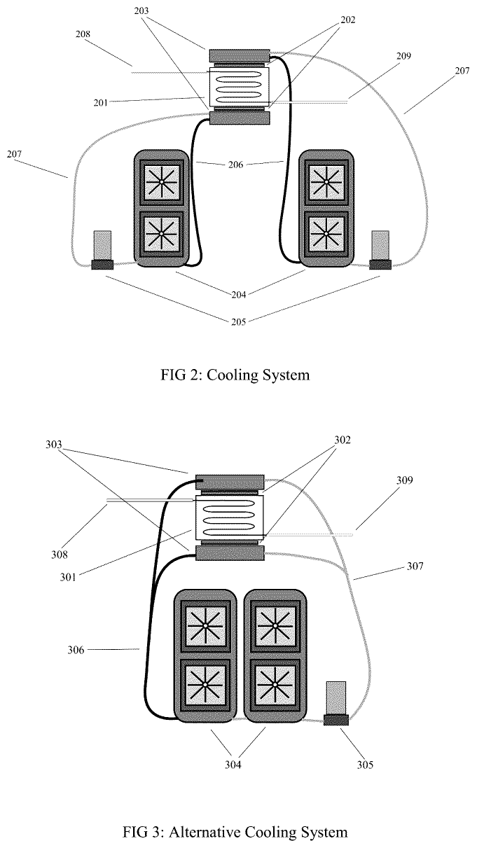

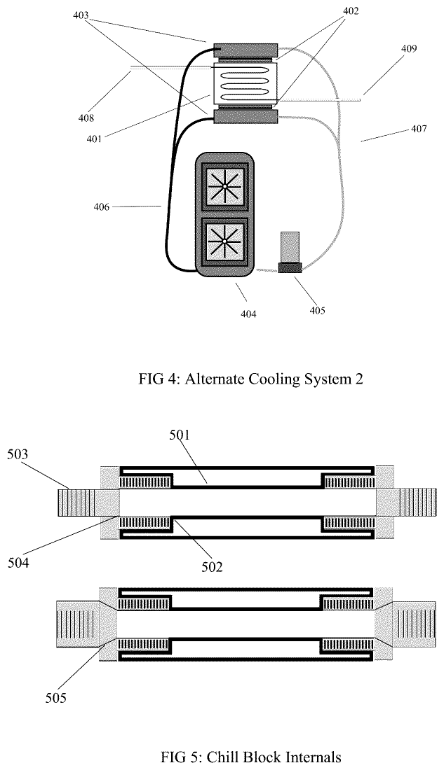

FIGS. 2, 3, and 4 are exemplary illustrations of the chill block 116 and cooling system 102. The chill block 116 (FIG. 1)/201 (FIG. 2)/301 (FIG. 3)/401 (FIG. 4) is part of the chiller loop 101 previously mentioned. The chill block 201 has an input 208 (FIG. 2)/308 (FIG. 3)/408 (FIG. 4) and output 209 (FIG. 2)/309 (FIG. 3)/409 (FIG. 4) with between 1 and 500 internal turns to increase the contact time with the beverage for increased chilling efficiency. The disadvantage of the beverage contacting more surfaces is that more residual liquid may be left behind. By constantly circulating the beverage from the beverage container 112 to the chill block 201 enables the beverage liquid to pull the cold temperature from the chill block 201 quickly and keep the beverage contact with the machine limited to the surfaces within the chiller loop 101.

In embodiments, the chill block 201 has a mass of between 0.01 and 5 kilograms and can be made from copper, aluminum, diamond, silver, brass, lead, steel and/or a combination of these materials. The mass and materials are important for thermal conductivity and thermal capacity. In embodiments, the internal turns of the chill block 201 are covered with Polytetrafluoroethylene, Polychlorotrifluoroethylene, Perfluoroalkoxy, Tetrafluorethylene-perfluoropropylene, Thermoplastic, or a non-stick coating to prevent any beverages from impacting the chill block materials or impacting the flavors of the beverage. The thinner the protective covering, the more efficient the thermal transfer.

FIG. 5 is an exemplary illustration of the chill block interconnections. The chill block interconnections create a smooth interface to minimize sharp edges that can retain liquids. The connector 503 on the chill block has two interfaces with the chill block 504 and 502 that are at the same level as the passageways in the chill block 501. In another embodiment, the tubes along the chiller loop 101 are larger than the chill block 501 passageways having a gradual shift in tube sizing 505, enabling less fluid to be retained between chill block interconnections and more efficient flushing of the chill block 501 passageways.

The chill block 201 is chilled through thermoelectric coolers (TECs) 114 (FIG. 1)/202 (FIG. 2)/302 (FIG. 3)/402 (FIG. 4). The cold side of the TECs 202 is placed on the chill block 201 with thermal paste to increase thermal conductivity. Two hot blocks 113 (FIG. 1)/203 (FIG. 2)/303 (FIG. 3)/403 (FIG. 4) are placed on the hot side of each TEC 202 with thermal paste to increase thermal conductivity. In another embodiment, the chill block 201 is large enough to have a TEC 202 on each side, excluding the chill block 201 input and output resulting in up to 5 TECs. The purpose of the cooling system 102 (FIG. 1) is to decrease the temperature difference between the hot and cold side of the TECs 202, to maximize the thermal transfer at the chill block 201. The more heat removed/absorbed from the hot blocks 203, the smaller the difference in temperature between the hot and cold side of the chill block 201 increasing the chilling efficiency. The hot block 203 is water cooled with hot water 206 (FIG. 2)/306 (FIG. 3)/406 (FIG. 4) going directly to the radiator(s)/radiator fan(s) 204 (FIG. 2)/304 (FIG. 3)/404 (FIG. 4) and a radiator water reservoir/radiator pump combination(s) 205 (FIG. 2)/305 (FIG. 3)/405 (FIG. 4) pumping cooled water 207 (FIG. 2)/307 (FIG. 3)/407 (FIG. 4) back to the hot block 203.

In embodiments, the hot block 203 can have between 1 and 500 internal turns internally and can be made from copper, aluminum, diamond, silver, brass, lead, steel and/or a combination of these materials. The hot block 203 has a mass between 0.01 and 5 kilograms. The size of the hot block 203 is particularly important for the thermal capacity.

In embodiments, the radiator water reservoirs 205 is between 1 and 10,000 ml to increase the total thermal capacity of the system. In embodiments, the radiator pumps 205 is capable of between 1 and 10,000 Liters per Hour. The radiators 204 have a corner-to-corner length between 10 and 1000 mm and a thickness between 1 and 100 mm. The radiator cores (in the radiators 204) can be made of copper or aluminum. The radiator fans 204 have a corner-to-corner length between 20 and 500 mm and a thickness between 1 and 100 mm. The radiator fans 204 have a maximum rotation speed between 100 and 20,000 rotations per minute. The higher the thermal capacity, the less the temperature will change over a single dispense. The better heat is removed from the system, the better the cooling over continuous dispenses.

In another embodiment, one radiator pump 305 is used with the two radiators 304 in a sequential order and the input to the radiators 306 is merged from both the hot blocks 303 while the output of the radiator pump 305 is split to the two hot blocks 303. In another embodiment, the hot blocks 303 are connected sequentially so there is only a single output from the hot blocks 303 to the radiators 304 and there is only a single output from the radiator pump 305 to the hot blocks 303. The sequential setup is not as preferable since one of the hot blocks 303 will have a higher temperature difference and thus the chilling efficiency of the chill block 301 will be decreased. The order of the cooling components is inconsequential to the design and may be placed with radiator 304 to hot block 303 to radiator pump 305 or radiator 304 to radiator pump 305 to hot block 303.

In another embodiment, a single radiator 404 and radiator pump 405 is used with the two hot blocks 403 with the two hot block outputs 406 merging to the input on the radiator. The radiator pump 405 output splitting to the two hot block inputs 407. In another embodiment, the hot blocks 403 are connected sequentially so there is only a single output from the hot blocks 403 to the radiators 404 and there is only a single output from the radiator pump 405 to the hot blocks 403. The order of the components may be placed with radiator 404 to hot block 403 to radiator pump 405 or radiator 404 to radiator pump 405 to hot block 403.

In another embodiment, the radiators 204 are placed above the chill block 201 and hot blocks 202. The benefit of this approach is if there is air in the cooling system 102, the air would be kept in the radiator and not the hot blocks 202. Air inside the hot block 202 would decrease thermal conductivity significantly. The disadvantage of the radiator at the highest point is that the height of the system would increase.

### Controls

Internally, there may be a connectivity module that can be completely turned on or off including Bluetooth™ (BLE), Wireless Fidelity (Wifi), Long-term Evolution™ (LTE), LTE-M™, Narrowband IoT (NB-IoT), 3G/4G/5G, SigFox™, Zigbee™, Long Range Wide Area™ (LoRa) or a sub-GHz frequency band for power savings. This connectivity module may connect to a gateway that connects to the internet or to connect directly to the internet. In any of these connectivity solutions, an antenna would be used internal to the system. The beverage dispensing system is connected to a mobile phone through Bluetooth™. The commercial version of the beverage dispensing system may offer cellular based communications and the consumer version may offer non-cellular based communications.

A user would follow these steps to utilize the beverage dispensing system: step 1) the user places the straw system 103 into the beverage container 112; step 2) the user installs the straw system 103 with beverage container 112 to the system; step 3) the user selects a beverage to dispense on the LCD screen 602 to start the dispense; step 4) the beverage dispensing system lcd 602 displays the current status of the dispense; step 5) the user may remove the straw system 103 for cleaning; and step 6) the user may enjoy the beverage. In another embodiment, the user can use a mobile application to take a picture of the wine label. With the mobile application paired to the beverage dispensing system, the dispense will start. When the mobile application is utilized, the mobile application communicates with a cloud platform to identify one or more of the beverage brand, a location of production, a type of beverage, production date, production method, ratings, reviews, packaging facility, date of packaging, recommended food pairings, categorized flavors, ideal serving temperature, ideal aeration, ingredients, ideal age, acidity, color, smell, alcohol content, volume of beverage, user settings, and system settings. This information and in-depth information about the beverage are relayed to the beverage dispensing system to be displayed on a touch lcd screen 602 and/or displayed on the mobile application. In another embodiment, the beverage dispensing system has at least one button and led or at least one button and lcd screen 602 instead of a touch lcd screen 602. Through the mobile application, user settings and system settings may be customized and set to override the ideal target temperature/aeration for the beverage.

Once a beverage is chosen or has been identified, the beverage dispensing system will begin a dispense following the beverage dispensing guidelines. The beverage dispensing guidelines includes methods discussed above to chill/heat a beverage to a target temperature and/or aerate the beverage to a target aeration duration (based on estimated volume of beverage). If there is no beverage found, the beverage dispensing system may request the beverage straw 103 to be placed in the beverage container 112 to start the dispense and the user may be prompted to press a button to start the dispense when ready. The system may discern if there is a beverage available by checking the temperature sensor 106 and if the temperatures remain unchanged, may notify the user that the beverage is missing.

During the dispense, the lcd 602 may show the current status of the dispense including one or more of the current beverage temperature, a radiator reservoir fluid temperature, an estimated time to beverage target temperature, estimated volume of beverage, elapsed dispense time, target temperature, ambient temperature, and target aeration.

At the beginning of each dispense (and at system power on), the system may check to see if a beverage change has occurred. A change in beverage may occur when the beverage selected has changed in type. For example, a medium bodied red wine to a full-bodied red wine is may not be a change in the beverage type. Whereas a white wine changed to a red wine may be considered a change in the beverage type, despite both being wines. If a change has occurred, a cleaning may automatically be requested and required.

After a dispense occurs, the user may have the option to rate the beverage. This rating may be saved to the user's account to better understand the user's preferences. Beverage ratings may include a value between 1 and 50, a text input for describing the beverage, or pre-selected options including, but not limited to, separate ratings for acid, buttery, tannins, charcoal, crisp, dense, peach, velvety, savory, fruit, oak, almond, mineral, sweetness, raspberry, cherry, blackberry, toffee, vanilla, tobacco, raisin, lemon, apple, orange, orange, mango, pineapple, caramel, cantaloupe, pear, brulee, pepper, peppercorn, rhubarb, currant, gravel, underbrush, wood, sage, leather, tar, herbs, olive, apple, thyme, grass, lime, pith, quince, grapefruit, gooseberry, petrichor, chervil, jalapeno, dry, melon.

The cloud platform in conjunction with the communication module enables Over the Air (OTA) updates to the system for changes. OTA may be used to update performance controls for internal components, including pumps, sensors, and/or TECs. Additionally, OTA can be used for updating user interface (e.g. LCD screens), fix bugs, and/or update stored data.

Storage is available to store data if the communication module cannot reach an end node and/or the system is turned on/off. Storage may be used for one or more of failure codes, component calibrations, system settings, user settings, user usage information, beverage information, user interface data, and/or beverage vessel identifiers.

It is to be understood that the TECs 114 and cooling system 102 may be used in turn to heat the beverage with a reverse current.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A beverage dispensing system comprising:
a pump for cleaning residual liquids in the system;
a chiller loop with components from highest to lowest level comprising:
a beverage pump for circulating the beverage through the chiller loop,
a chill block with a beverage passageway for minimizing liquid residual and
one or more TECs for chilling or heating the chill block; and
one or more input and output tubes to connect the chiller loop to the beverage comprising:
an input tube for suctioning the beverage into the chiller loop, and
an output tube for pushing the beverage out of the chiller loop.

2. The beverage dispensing system of claim 1, wherein the chill block has no sharp edges to minimize residual liquids that may stay inside after a dispense or cleaning occurs.

3. The beverage dispensing system of claim 1, wherein an air pump for removing residual liquids in the system, located at the highest point in the system, utilizes one or more valves to control the air direction and strength, by pushing and agitating the residual liquids to flow with gravity out of the system.

4. The beverage dispensing system of claim 1, further comprising:
a temperature sensor attached to the input tube on the chiller loop that measures when the beverage target temperature is reached.

5. The beverage dispensing system of claim 1, further comprising:
at least one of a conductance sensor, optical sensor, capacitance sensor, ultrasonic sensor, or tube level sensor to measure if liquids are present in or around the tubes.

6. The beverage dispensing system of claim 1, wherein the beverage straw system may be extended a variable length to come into contact with the beverage.

7. The beverage dispensing system of claim 1, wherein the beverage straw system may be removed and/or replaced.

8. The beverage dispensing system of claim 1, wherein the heat of the one or more TECs is absorbed by one or more hot blocks and cold of the one or more TECs is absorbed by one or more hot blocks.

9. The hot blocks of claim 8, wherein the heat/cold is dissipated through one or more radiator pumps, one or more radiator fluid reservoirs, radiator fluid, one or more radiators, and one or more radiator fans.

10. The beverage dispensing system of claim 1, wherein an air pump is used during the beverage dispense for aerating the beverage.

11. The pump of claim 10, wherein the pump is cycled on and off at a specific frequency and duration to target a specific aeration for the specific beverage.

12. A method of processing a beverage by a beverage dispensing system, the method comprising:
receiving data to a processor regarding the beverage to be processed the data including at least one of a beverage information and a beverage dispensing guidelines;
determining the beverage information and the beverage dispensing guidelines from the data and displaying, processing, and dispensing beverages based on the data;
instructing, by the processor, a pump and at least one valve to direct the beverage from the beverage container to the chill block, circulating the beverage through a chiller loop;
detecting a temperature of the beverage via a temperature sensor until ideal serving temperature is reached;
instructing, by the processor, a pump and at least one air valve to direct air to the aerator.

13. A method of claim 12, wherein the receiving data is coming from a mobile application taking and processing an image of the beverage.

14. A method of claim 12, wherein the pump for aeration is controlled, by the processor, to turn on and off at a frequency and duration to meet the target ideal aeration for the beverage.

15. A method of claim 12, wherein the data includes at least one of a beverage brand, a location of production, a type of beverage, production date, production method, ratings, reviews, packaging facility, date of packaging, recommended food pairings, categorized flavors, ideal serving temperature, ideal aeration, ingredients, ideal age, acidity, color, smell, alcohol content, volume of beverage, user settings, and system settings.

16. A method of claim 12, further comprising interpreting the data through the processor to be displayed.

17. A method of claim 12, further comprising determining when a beverage is processed from the data and generating a notification to a cloud platform.

18. A method of claim 12, further comprising receiving external data from a cloud platform based on the data.

19. A method of claim 18, further comprising displaying information from external data on a display.

20. A method of claim 12, further comprising relaying the dispensing systems' current state to a mobile application.

21. A method of claim 20, wherein the current state includes at least one of a current beverage temperature, a radiator reservoir fluid temperature, an estimated time to beverage target temperature, estimated volume of beverage, elapsed dispense time, target temperature, ambient temperature, and target aeration.

22. A method of rating a beverage by a beverage dispensing system, the method comprising:
after completing a dispense, displaying options for rating the latest beverage;
detecting user inputs on a beverage rating;
receiving a beverage rating to a processor; and
instructing, by the processor, to publish the beverage rating.

23. A method of claim 22, wherein the beverage dispensing system is associated with a user account.

24. A method of claim 22, wherein the beverage rating can consist of a value between 1 and 50, a text input for describing the beverage, or pre-selected options including, but not limited to, separate ratings for acid, buttery, tannins, charcoal, crisp, dense, peach, velvety, savory, fruit, oak, almond, mineral, sweetness, raspberry, cherry, blackberry, toffee, vanilla, tobacco, raisin, lemon, apple, orange, orange, mango, pineapple, caramel, cantaloupe, pear, brulee, pepper, peppercorn, rhubarb, currant, gravel, underbrush, wood, sage, leather, tar, herbs, olive, apple, thyme, grass, lime, pith, quince, grapefruit, gooseberry, petrichor, chervil, jalapeno, dry, melon.

25. A method of claim 22, wherein the option for rating the beverage can be displayed on mobile application, web, or the beverage dispensing system.
